(19) United States
(12) Patent Application Publication
(10) Pub. No.: US 2025/0149886 A1
(43) Pub. Date: May 8, 2025

(54) SETTING METHOD FOR RESILIENT CHECKPOINTING BASED ON MACHINE LEARNING

(71) Applicant: Capital Normal University, Beijing (CN)

(72) Inventors: Keni Qiu, Beijing (CN); Chuting Xu, Beijing (CN); Kunyu Zhou, Beijing (CN); Dehui Qiu, Beijing (CN)

(21) Appl. No.: 18/431,933

(22) Filed: Feb. 3, 2024

(30) Foreign Application Priority Data
Nov. 6, 2023 (CN) 2023114598787

(51) Int. Cl. H02J 3/00

(52) U.S. Cl. CPC H02J 3/0012; H02J 3/003

(57) ABSTRACT

Provided is a setting method for resilient checkpointing based on machine learning, which predicts a future power level in advance through a lightweight power level predictor and dynamically adjusts checkpoint intervals to accommodate a future energy input. During the operation of a power harvesting system, a resilient checkpointing mechanism assigns an appropriate checkpoint interval to a future power cycle to match a current harvesting power based on a state of a future harvesting power. Therefore, the power harvesting system with the resilient checkpointing mechanism can realize low checkpointing overhead and rollback punishment. The method involves a lightweight power level predictor based on a fully connected neural network and a resilient checkpoint setting mechanism based on power level prediction, which determines a checkpoint interval of a current cycle based on a predicted power level of a future power cycle.

### TECHNICAL FIELD

The disclosure relates to the technical field of computer architecture and storage technology, and particularly to a setting method for resilient checkpointing based on machine learning.

### BACKGROUND

In recent years, on the one hand, internet of things (IoT) technology has developed rapidly, and edge computing devices have gained widespread attention as infrastructure for the IoT, such as wildlife monitoring devices and implantable medical devices. On the other hand, with the continuous development of energy harvesting technologies, IoT devices can be powered by harvesting energy from the ambient energy (e.g., solar, wind and RF such as thermal energy and kinetic energy) for their own use without the need of battery power supply. Using self-powered technologies (i.e., the energy harvesting technologies) for power supply has many advantages, such as green economy, and no need to replace/maintain battery for charging; and the energy harvesting technologies bring great opportunities for IoT edge computing devices such as wearable devices, eco-monitoring devices, and body medical health monitoring in vitro and in-vivo.

However, the ambient power used for harvesting is often unstable due to weather, ambient conditions, or other factors, and frequent power outages that result in intermittent operation of a corresponding device pose a challenge to reliability and continuity of the corresponding device. Therefore, checkpointing is a key technique to guarantee execution correctness and ensure progress forwarding in energy harvesting systems. The main idea of the checkpointing is to periodically back up states of system data and program execution, and then restore a system to the latest backup state when power is restored, thereby ensuring the continuous execution of system.

However, the checkpointing introduces system overhead due to extra operations of data movements between volatile memory and non-volatile memory, and when the system is powered again after a power failure, the system is required to perform a rollback to the latest checkpoint, as such, tasks, which have already been executed, may be re-executed, and the overhead of the rollback is highly correlated with the latest checkpoint interval. That is, if the checkpoint interval setting does not match the power input characteristics, these two kinds of overhead, i.e., the overhead of setting up checkpoints and the overhead of programming rollback required in recovering from a power failure, can be quite high. In the first method, shorter checkpoint intervals have often been used in the past to minimize progress loss during re-execution rollback, but this undoubtedly results in higher latency and increased power overhead. In the second method, variable checkpoint interval has been proposed, which initiates with a long interval during power-on frame and then progressively reduces it, driven by the belief that power failure risk increases over time. Compared with the first method, the second method reduces the number of checkpoint to some extent, thereby reducing system overhead.

However, both of the first and second methods ignore a critical factor of unstable power supply in the energy harvesting system and do not take into account the impact of power input characteristic on checkpointing. Therefore, if the power input characteristic and the setting of checkpoint interval are combined, the correct and continuous execution of the program can be achieved under unstable ambient energy supply. This combining makes it possible to utilize machine learning to predict a future power level trend to guide setting of checkpoint interval of the current cycle.

### SUMMARY

The disclosure is provided to address the above problems in the prior art. Therefore, a setting method for resilient checkpointing based on machine learning is needed, which predicts a future power level in advance through a lightweight power level predictor and dynamically adjusts a checkpoint interval to accommodate a future energy input.

According to an embodiment of the disclosure, it is provided a setting method for resilient checkpointing based on machine learning including: constructing a power level predictor; inputting input parameters including an initial ambient power, and a power average value and a power variance value of n power cycles before the current power cycle into the power level predictor to obtain a predictor output of the power level predictor, wherein n≥2, and the predictor output is a predicted power level of the future power cycle. And determining a checkpoint interval of the current power cycle, based on the predicted power level of the future power cycle and the characteristic of an input power source.

In an embodiment, the constructing the power level predictor includes: constructing the power level predictor by using a fully connected neural network (FCNN). The power level predictor is configured to: establish a nonlinear relationship between the input parameters and the predictor output, and to predict the predicted power level of the future power cycle based on the nonlinear relationship.

In an embodiment, the power level predictor includes an input layer, two hidden layers and an output layer sequentially connected in that order. The input layer is configured to obtain the initial ambient power, the power average value and the power variance value of n power cycles before the current power cycle; the two hidden layers are configured to establish the nonlinear relationship between the input parameters and the predictor output; the output layer is configured to output the predicted power level of the future power cycle.

In an embodiment, based on the predicted power level of the future power cycle and the characteristic of the input power source, the following formulas determine the checkpoint interval of the current power cycle:

$$intv ( {PL}_{N} ) = ( α N + 1 ) \cdot {intv}_{init}$$

$$α = {{Norm}_{( 0 , 1 )} ( std )}^{- 1 / 2} ,$$

where intv(PL_{N}) represents the checkpoint interval of the current power cycle, a represents the characteristic of the input power source, N represents the predicted power levels of the future power cycle, intvᵢₙᵢₜ represents an initial checkpoint interval, Norm represents a linear normalization function, and std represents a standardization function.

In an embodiment, after determining the checkpoint interval of the current power cycle, based on the predicted power level of the future power cycle and the characteristic of the input power source, the setting method further includes:
obtaining, by a power predictor, a correct power level at a beginning of the current power cycle;
determining whether the predicted power level of the future power cycle is correct based on the correct power level; and
in response to the predicted power level of the future power cycle being incorrect, abandoning an active interval configuration and returning to a latest checkpoint.

In an embodiment, the in response to the predicted power level of the future power cycle being incorrect, abandoning the active interval configuration and returning to the latest checkpoint, includes:
in response to mispredicting a power-off level as a power-on level, assigning a target interval value to the current power cycle;
in response to mispredicting a power-on level as a power-off level, assigning a target value to the checkpoint interval of the future power cycle;
in response to mispredicting a lower power level as a higher power level, shortening the checkpoint interval of the current power cycle; and
in response to mispredicting a higher power level as a lower power level, increasing the checkpoint interval of the current power cycle.

According to an embodiment of the disclosure, a device for setting resilient checkpointing based on machine learning is provided, which includes: a predictor constructing module and a resilient detection module. The predictor constructing module is configured to construct a power level predictor, input parameters of the power level predictor include an initial ambient power, a power average value and a power variance value of n power cycles before the current power cycle; and the predictor output of the power level predictor includes a predicted power level of the future power cycle, where n≥2. The resilient detection module is configured to determine a checkpoint interval of the current power cycle based on the predicted power level of the future power cycle and the characteristic of an input power source.

In an embodiment, the device further includes: an error-processing module and a power predictor,
the power predictor is configured to obtain a correct power level at a beginning of the current power cycle;
the error-processing module is configured to:
   obtain the correct power level at a beginning of the current power cycle from the power predictor;
   determine whether the predicted power level of the future power cycle is correct based on the correct power level; and
   in response to the predicted power level of the future power cycle being incorrect, abandon an active interval configuration and return to a latest checkpoint.

In an embodiment, the error-processing module is configured to:
in response to mispredicting a power-off level as a power-on level, assign a target interval value to the current power cycle;
in response to mispredicting a power-on level as a power-off level, assign a target value to the checkpoint interval of the future power cycle;
in response to mispredicting a lower power level as a higher power level, shorten the checkpoint interval of the current power cycle; and
in response to mispredicting a higher power level as a lower power level, increase the checkpoint interval of the current power cycle.

The beneficial effects of the disclosure are as follows:
(1) The disclosure effectively reduces the number of checkpoints and overhead, benefiting from a resilient checkpointing policy that anticipates future power trends and allows for resilient checkpointing intervals to avoid executing more checkpoints that are unnecessary;
(2) The disclosure effectively reduces system rollback punishment, benefiting from the ability to proactively allocate shorter time intervals to mitigate the system overhead required to roll back to the latest checkpoint to continue program execution when a low power-on level or even a power failure is known to be imminent.

### BRIEF DESCRIPTION OF DRAWINGS

FIG. 1 illustrates a structural diagram of a framework for a resilient checkpointing mechanism according to an embodiment of the disclosure.

FIG. 2 illustrates an overall flowchart of a setting method for resilient checkpointing based on machine learning according to the embodiment of the disclosure.

FIG. 3 illustrates an architecture diagram of a fully-connected neural network for predicting a power level according to the embodiment of the disclosure.

FIG. 4 illustrates a flowchart of another setting method for resilient checkpointing based on machine learning according to an embodiment of the disclosure.

FIG. 5 illustrates a schematic structural view of a device for setting resilient checkpointing based on machine learning according to an embodiment of the disclosure.

FIG. 6 illustrates a schematic structural view of another device for setting resilient checkpointing based on machine learning according to an embodiment of the disclosure.

### DETAILED DESCRIPTION OF EMBODIMENTS

In order to help those skilled in the art better understand the technical solutions of the disclosure, a detailed explanation of the disclosure will be provided below in conjunction with the attached drawings and specific embodiments. The following provides a further detailed description of the embodiments of the disclosure in conjunction with the attached drawings and specific embodiments, but does not serve as a limitation of the disclosure. If there is no necessity for the steps described in the disclosure to have a logical relationship with each other, the order in which they are described as embodiments in the disclosure should not be considered a limitation. Those skilled in the art should know that they can be adjusted in order as long as the logical relationship between them is not disrupted, making the entire process impossible to implement.

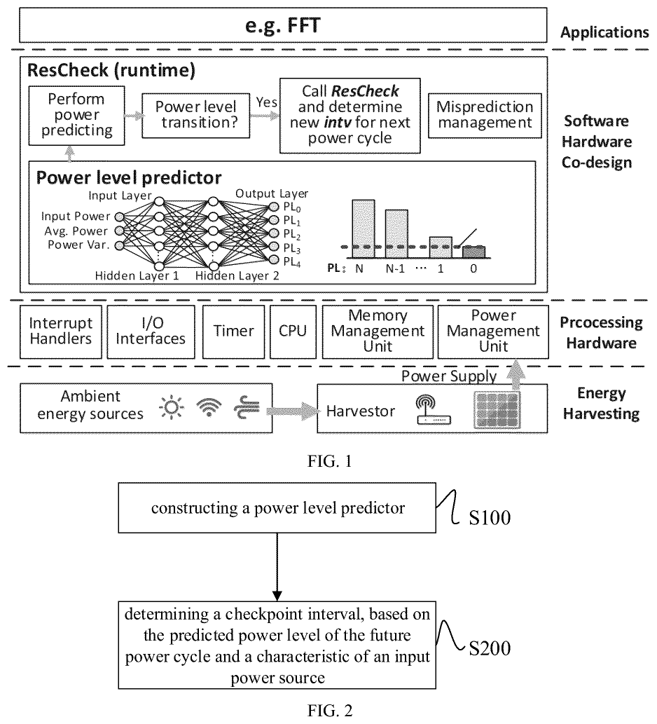

In an embodiment, FIG. 1 illustrates a structural diagram of a framework for a resilient checkpointing mechanism according to an embodiment. The framework for the resilient checkpointing mechanism is provided, which is used to achieve a setting method for resilient checkpointing based on machine learning. The framework for the resilient checkpointing mechanism includes a power level predictor, a recheck module, a hardware module, i.e., a processing hardware, and an energy harvesting module. The hardware module includes an interrupt handle, an input/output (I/O) interface, a timer, a memory management unit, and a power management unit. The power level predictor works in conjunction with the recheck module to achieve the resilient checkpoint setting, which can be configured in a processor. A harvestor of the energy harvesting module is used to collect ambient power, and then supply the collected ambient power to the power management unit. That is, initial ambient power collected during each power cycle can be obtained through the power management unit and then fed to the power level predictor.

In an embodiment, FIG. 2 illustrates an overall flowchart of a setting method for resilient checkpointing based on machine learning according to an embodiment. The method can be implemented based on the framework shown in FIG. 1, and the setting method includes S100-S200 as follows.

In S100, a power level predictor is constructed. Input parameters including an initial ambient power, a power average value and a power variance value of n power cycles before the current power cycle are input into the power level predictor to obtain a predictor output of the power level predictor, where n≥2, and the predictor output is a predicted power level of the future power cycle (i.e., the next power cycle).

It should be noted that the initial ambient power, the power average value and the power variance value of n power cycles before the current power cycle may be the signal strength of power, the average value of signal strength and the variance value of signal strength. The signal strength of power can be obtained by the power management unit through processing power, and the power obtained by the power management unit is collected by the harvestor of the energy harvesting module from its ambient environment. The average value of signal strength and the variance value of signal strength can be obtained by using statistical formulas based on signal strengths collected in preset number n of power cycles. For example, n can be set to 5, and the average value of signal strength and the variance value of signal strength represent an average value and a variance value of power collected in 5 power cycles. The description of the specific value of n in the embodiment is merely exemplarily. In practical application, any other positive integer greater than or equal to 2 can be selected. The specific value of n is not limited in the embodiment.

It should be noted that the processor described herein may be a processing device that includes one or more general processing devices, such as a microprocessor, a central processing unit (CPU) and a graphics processing unit (GPU). More specifically, the processor may be a complex instruction set computing (CISC) microprocessor, a reduced instruction set computing (RISC) microprocessor, a very long instruction word (VLIW) microprocessor, a processor running another instruction set, or a processor running a combination of instruction sets. The processor may also be more than one specialized processing device, such as an application-specific integrated circuit (ASIC), a field-programmable gate array (FPGA), a digital signal processor (DSP) and a system-on-a-chip (SoC).

The power level described in the embodiment refers at least two power levels according to the actual situation or the needs of a computing system.

In some embodiments, the power level predictor is constructed by using a fully connected neural network (FCNN). The power level predictor is configured to: establish a nonlinear relationship between the input parameters and the predictor output, and to predict the predicted power level of the future power cycle based on the nonlinear relationship.

It should be noted that FCNN can achieve an efficient predictive method that is powerful in its ability to establish complex nonlinear relationships between the input parameters and the predictor output. In its mimicry of a biological nervous system, the FCNN is made up of multiple neurons interconnected with each other, making it capable of capturing potentially complex patterns and trends in the data, whether the patterns are linear or nonlinear. This ability has allowed the neural networks to excel in a variety of fields, including image recognition, natural language processing, and predictive analytics.

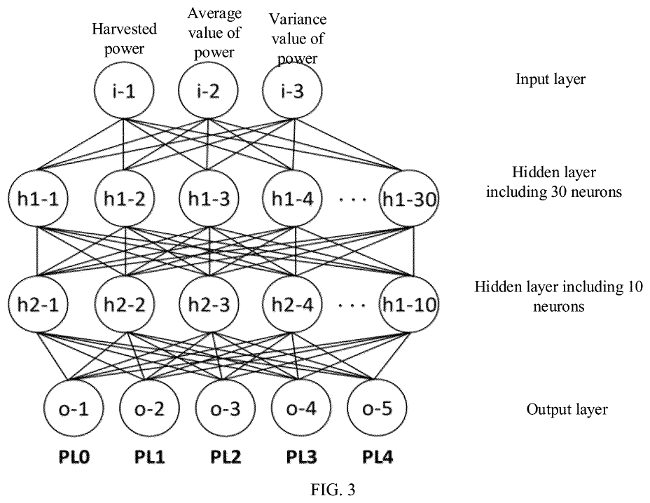

FIG. 3 illustrates an architecture diagram of the fully connected neural network for predicting the power level according to the embodiment. The power level predictor includes an input layer, two hidden layers and an output layer sequentially connected in that order. The input layer is configured to obtain the initial ambient power, the power average value and the power variance value of the n power cycles before the current power cycle; The two hidden layers are configured to establish the nonlinear relationship between established the input parameters and the predictor output; And the output layer is configured to output the predicted power level of the future power cycle.

In an embodiment, the input layer includes three input nodes, and the three input nodes are used to obtain a collected power, e.g. the initial ambient power, a power average value, and a power variance value, respectively. The two hidden layers are a hidden layer 1 and a hidden layer 2, where the hidden layer 1 includes 30 neurons and the hidden layer 2 includes 10 neurons, which are used to establish the nonlinear relationship between the input parameters and the predictor output. The embodiment herein partitions the power level (PL) into five power levels (PL₀ to PL₄) according to the actual situation or the demand of the computing system, PL₀ means power failure where the power strength is less than the system activating threshold, PL₁˜PL₄ denotes the power levels with which the system can operate normally and PL₄ denotes the power level with the highest power input scope.

Correspondingly, the output layer can include five output nodes according to the prediction result, the corresponding output nodes can output the corresponding power levels of the future power cycle.

In S200, a checkpoint interval of the current power cycle is determined based on the predicted power level of the future power cycle and the characteristic of an input power source.

It should be noted that a basic working principle of S200 is based on the implementation of a checkpointing technique. The main idea of the checkpointing technique is to periodically back up the system state and data, which typically include memory contents, register values and file system state. These contents are stored on a nonvolatile memory for use when needed. In the event of a power failure or the need for recovery, a computation process can be restarted and the latest checkpoints before the failure are loaded for continuing the execution. This can significantly improve the reliability and fault tolerance of the system. However, the checkpointing technique still causes overhead. Some computational and storage overhead may be introduced when creating and storing checkpoints, and excessively frequent checkpointing may also lead to performance degradation. Therefore, in practice, checkpoint intervals and performance overhead need to be weighed against the specific situation and requirements.

In a specific embodiment, a collected power level dataset of ambient power of power cycles is first standardized to obtain a standardized dataset, the standardized dataset is linearly normalized to obtain normalized data so that the standardized dataset has a uniform standard of comparison, followed by taking the inverse of the normalized data to squared, thereby obtaining a parameter a, and the parameter a is substituted into a resilient checkpoint setting formula as one of guiding parameters.

Based on the power level prediction and the guiding parameters, when there is a higher power level in the future power cycle, then a larger checkpoint interval can be boldly used to enjoy a lower checkpointing overhead. Otherwise, when a lower power level or even power-off level is predicted to occur, a shorter checkpoint interval can be proactively assigned to mitigate rollback punishments.

In some embodiments, the determining of the checkpoint interval of the current power cycle, based on the predicted power level of the future power cycle and the characteristic of the input power source, includes: determining the checkpoint interval of the current power cycle based on the following formulas:

$$intv ( {PL}_{N} ) = ( α N + 1 ) \cdot {intv}_{init}$$

$$α = {{Norm}_{( 0 , 1 )} ( std )}^{- 1 / 2} ,$$

Where intv(PL_{N}) represents the checkpoint interval of the current power cycle, a represents the characteristic of the input power source, N represents the predicted power level of the future power cycle, intvᵢₙᵢₜ represents an initial checkpoint interval, Norm represents a linear normalization function, and std represents a standardization function.

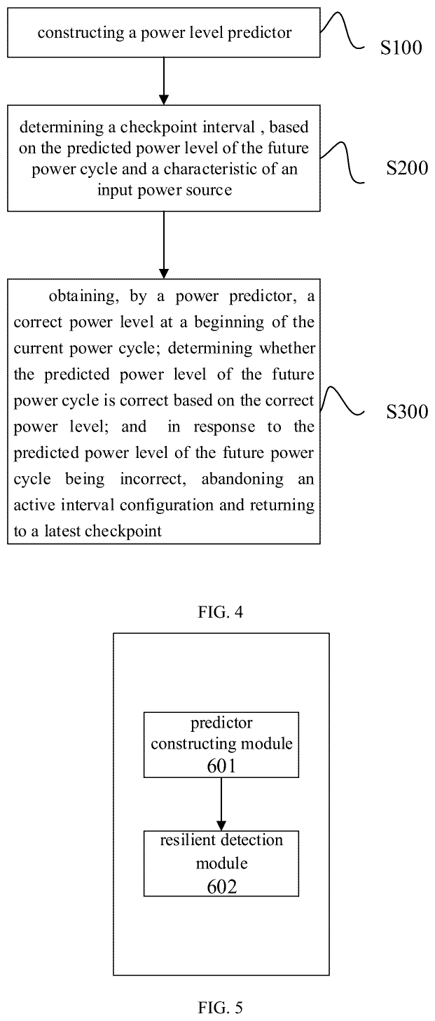

In some embodiments, FIG. 4 illustrates a flowchart of another setting method for resilient checkpointing based on machine learning according to the embodiment. After determining of the checkpoint interval of the current power cycle, based on the predicted power level of the future power cycle and the characteristic of the input power source, the setting method further includes the following step S300.

In S300, a correct power level at the beginning of the current power cycle is obtained by a power predictor; whether the predicted power level of the future power cycle is correct is based on the correct power level; and an active interval configuration is abandoned and returned to the latest checkpoint in response to the predicted power level of the future power cycle being incorrect. The corresponding treatments for mispredicting are described as follows.

Case 1: mispredicting a power-off level PL₀ as a power-on level PL₁-PL_{N}. According to the resilient checkpointing mechanism, when PL₀ is predicted for the future power cycle, the shortest checkpoint interval (i.e., a target checkpoint interval) is assigned to a future interval value. However, when the mispredicting occurs, the checkpoint interval is set larger than its expected shortest checkpoint interval and the system may suffer a greater rollback punishment.

Case 2: mispredicting a power-on level (PL₁-PL_{N}) as a power-off level PL₀. When the mispredicting occurs, the checkpoint interval is set with the shortest value (i.e., a target value) to prepare for the power failure. Apparently, the mispredicting is most likely to introduce a greater number of unnecessary checkpoints and greater checkpointing overhead.

Case 3: mispredicting a lower power-on level as a higher power-on level. When the mispredicting occurs, the checkpoint interval is longer than its expected checkpoint interval. Since the next power-on cycle is still in the power-on state, there is practically no cost incurred in this case.

Case 4: mispredicting a higher power-on level as a lower power-on level. When the mispredicting occurs, the checkpoint interval is shorter than its expected checkpoint interval, thereby increasing the checkpointing overhead.

As shown in FIG. 5, a device for setting resilient checkpointing based on machine learning is provided.

The device includes a predictor constructing module 601 and a resilient detection module 602, the predictor constructing module is configured to construct a power level predictor, which the input parameters of the power level predictor include an initial ambient power, a power average value and a power variance value of n power cycles before the current power cycle; the predictor output of the power level predictor includes a predicted power level of a future power cycle, where n≥2. The resilient detection module is configured to determine a checkpoint interval of the current power cycle based on the predicted power level of the future power cycle and the characteristics of an input power source.

In some embodiments, the predictor constructing module 601 is further configured to construct a power level predictor by using a fully connected neural network. The power level predictor is configured to establish a nonlinear relationship between the input parameters and the predictor output and to predict the predicted power level of the future power cycle based on the nonlinear relationship.

In some embodiments, the power level predictor includes an input layer, two hidden layers and an output layer sequentially connected in that order. The input layer is configured to obtain the initial ambient power, the power average value and the power variance value of the n power cycles before the current power cycle; the two hidden layers are configured to establish the nonlinear relationship between established the input parameters and the predictor output; and the output layer is configured to output the predicted power level of the future power cycle.

In some embodiments, the determining the checkpoint interval of the current power cycle, based on the predicted power level of the future power cycle and the characteristic of the input power source, includes: determining the checkpoint interval of the current power cycle based on the following formulas:

$$intv ( {PL}_{N} ) = ( α N + 1 ) \cdot {intv}_{init}$$

$$α = {{Norm}_{( 0 , 1 )} ( std )}^{- 1 / 2} ,$$

where intv(PL_{N}) represents the checkpoint interval of the current power cycle, a represents the characteristic of the input power source, N represents the predicted power level of the future power cycle, intvᵢₙᵢₜ represents an initial checkpoint interval, Norm represents a linear normalization function, and std represents a standardization function.

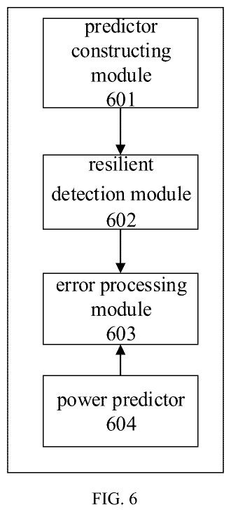

In some embodiments, as shown in FIG. 6, the device further includes: an error-processing module 603 and a power predictor 604, the error-processing module 603 is configured to:
obtain the correct power level at a beginning of the current power cycle from the power predictor;
determine whether the predicted power level of the future power cycle is correct based on the correct power level;
in response to the predicted power level of the future power cycle being incorrect, abandon an active interval configuration and return to a latest checkpoint.

In some embodiments, the error-processing module 603 is further configured to:
in response to mispredicting a power-off level as a power-on level, assign a target interval value to the current power cycle;
in response to mispredicting a power-on level as a power-off level, assign a target value to the checkpoint interval of the future power cycle;
in response to mispredicting a lower power level as a higher power level, shorten the checkpoint interval of the current power cycle; and
in response to mispredicting a higher power level as a lower power level, increase the checkpoint interval of the current power cycle.

It should be noted that the device described in the embodiment and the previously described method belong to the same technical concept and can achieve the same technical effect, which will not be elaborated on here.

The above description is intended to be explanatory rather than restrictive. For example, the above examples (or one or more of them) can be used in combination with each other. For example, those skilled in the art may use other embodiments when reading the above description. In addition, in the above specific embodiments, various features can be combined together to simplify the disclosure. This should not be interpreted as a feature of the disclosure that does not require protection as necessary for any claim. On the contrary, the subject matter of the disclosure may be less than all the features of specific embodiments of the disclosure. Therefore, the following claims are incorporated into specific embodiments as examples or embodiments, where each claim is independently considered as a separate embodiment, and these embodiments may be combined with each other in various combinations or arrangements. The scope of the disclosure shall be determined by reference to the attached claims and the full scope of the equivalent forms of rights granted to claims.

What is claimed is:

1. A setting method for resilient checkpointing based on machine learning, comprising:
constructing a power level predictor;
inputting input parameters comprising an initial ambient power, a power average value and a power variance value of n power cycles before a current power cycle into the power level predictor to obtain a predictor output of the power level predictor, wherein n≥2, and the predictor output is a predicted power level of a future power cycle; and
determining a checkpoint interval of the current power cycle, based on the predicted power level of the future power cycle and a characteristic of an input power source.

2. The setting method for resilient checkpointing based on machine learning as claimed in claim 1, the constructing the power level predictor comprises:
constructing the power level predictor by using a fully connected neural network (FCNN), wherein the power level predictor is configured to: establish a nonlinear relationship between the input parameters and the predictor output, and predict the predicted power level of the future power cycle based on the nonlinear relationship.

3. The setting method for resilient checkpointing based on machine learning as claimed in claim 2, wherein the power level predictor comprises an input layer, two hidden layers, and an output layer sequentially connected in that order;
the input layer is configured to obtain the initial ambient power, the power average value and the power variance value of the n power cycles before the current power cycle; the two hidden layers are configured to establish the nonlinear relationship between established the input parameters and the predictor output; and the output layer is configured to output the predicted power level of the future power cycle.

4. The setting method for resilient checkpointing based on machine learning as claimed in claim 1, wherein the determining the checkpoint interval of the current power cycle, based on the predicted power level of the future power cycle and the characteristic of the input power source, comprises: determining the checkpoint interval of the current power cycle based on the following formulas:
$$intv ( {PL}_{N} ) = ( α N + 1 ) \cdot {intv}_{init}$$
$$α = {{Norm}_{( 0 , 1 )} ( std )}^{- 1 / 2} ,$$
where intv(PL_{N}) represents the checkpoint interval of the current power cycle, a represents the characteristic of the input power source, N represents the predicted power level of the future power cycle, intvᵢₙᵢₜ represents an initial checkpoint interval, Norm represents a linear normalization function, and std represents a standardization function.

5. The setting method for resilient checkpointing based on machine learning as claimed in claim 1, wherein after the determining a checkpoint interval of the current power cycle, based on the predicted power level of the future power cycle and a characteristic of an input power source, the setting method further comprises:
obtaining, by a power predictor, a correct power level at a beginning of the current power cycle;
determining whether the predicted power level of the future power cycle is correct based on the correct power level; and
in response to the predicted power level of the future power cycle being incorrect, abandoning an active interval configuration and returning to a latest checkpoint.

6. The setting method for resilient checkpointing based on machine learning as claimed in claim 5, wherein the in response to the predicted power level of the future power cycle being incorrect, abandoning the active interval configuration and returning to the latest checkpoint, comprises:
in response to mispredicting a power-off level as a power-on level, assigning a target interval value to the current power cycle;
in response to mispredicting a power-on level as a power-off level, assigning a target value to the checkpoint interval of the future power cycle;
in response to mispredicting a lower power level as a higher power level, shortening the checkpoint interval of the current power cycle; and
in response to mispredicting a higher power level as a lower power level, increasing the checkpoint interval of the current power cycle.

7. A device for setting resilient checkpointing based on machine learning, comprising:
a predictor constructing module, wherein the predictor constructing module is configured to construct a power level predictor, input parameters of the power level predictor comprise an initial ambient power, and a power average value and a power variance value of n power cycles before the current power cycle; and a predictor output of the power level predictor comprises a predicted power level of a future power cycle, where n≥2; and
a resilient detection module, wherein the resilient detection module is configured to determine a checkpoint interval of the current power cycle based on the predicted power level of the future power cycle and a characteristic of an input power source.

8. The device for setting resilient checkpointing based on machine learning as claimed in claim 7, wherein the device further comprises: an error-processing module and a power predictor;
wherein the power predictor is configured to obtain a correct power level at a beginning of the current power cycle;
wherein the error-processing module is configured to:
obtain the correct power level at a beginning of the current power cycle from the power predictor;
determine whether the predicted power level of the future power cycle is correct based on the correct power level; and
in response to the predicted power level of the future power cycle being incorrect, abandon an active interval configuration and return to a latest checkpoint.

9. The device for setting resilient checkpointing based on machine learning as claimed in claim 8, wherein the error-processing module is configured to:
in response to mispredicting a power-off level as a power-on level, assign a target interval value to the current power cycle;
in response to mispredicting a power-on level as a power-off level, assign a target value to the checkpoint interval of the future power cycle;
in response to mispredicting a lower power level as a higher power level, shorten the checkpoint interval of the current power cycle; and
in response to mispredicting a higher power level as a lower power level, increase the checkpoint interval of the current power cycle.
